(19) United States
(12) Patent Application Publication
(10) Pub. No.: US 2003/0158031 A1
(43) Pub. Date: Aug. 21, 2003

(54) Microwave dielectric ceramic composition and a process for the preparation thereof

(76) Inventors: Naseemabeevi Jawahar Isuhak, Kerala (IN); Thomas Sebastian Mailadil, Kerala (IN)

Correspondence Address: Morgan & Finnegan L.L.P., Maria C.H. Lin, 345 Park Avenue, New York, NY, 10154-0053, US

(21) Appl. No.: 10/032,769

(22) Filed: Dec. 27, 2001

(51) Int. Cl. C04B 35/495

(52) U.S. Cl. 501/134

(57) ABSTRACT

The present invention discloses a novel microwave dielectric composition of the general formula 5AO-2B₂O₅ wherein A=Ba, Sr, Ca, Mg or Zn and B=Nb or Ta, and a process for the preparation thereof In one embodiment of the invention, the dielectric constant is in the range 11±1 to 42±1, quality factor—frequency in the range 2000 and 88,000 and temperature coefficient of resonant frequency in the range +140±7 and −73±5 ppm/° C.

### FIELD OF THE INVENTION

The present invention relates to a microwave dielectric ceramic composition and to a process for the preparation thereof. More particularly, the present invention relates to a microwave dielectric ceramic composition of the formula 5AO-2B₂O₅ (A=Ba, Sr, Ca, Mg, Zn; B=Nb, Ta) and to a process for the preparation thereof.

### BACKGROUND OF THE INVENTION

Dielectric resonators require high dielectric constant (εᵣ=10-100) for miniaturization, high quality factor (Q>2000) for selectivity and low temperature variation of resonant frequency (τ_{f}<|20|ppm/° C.) for stability while used in practical circuits for microwave applications. Conventional ceramics for use in such applications include BaO—TiO₂ system, Ba(Mg_{1/3}Ta_{2/3})O₃, Ba(Zn_{1/3}Ta_{2/3})O₃, (Zr, Sn)TiO₃ etc. But their applications are limited by the low dielectric constants because the size of the system is inversely proportional to the εᵣ^{1/2}. Materials with different dielectric constants are required for different applications.

Ba₅Nb₄O₁₅ type hexagonal perovskites have high dielectric constant and high Q factor. H. Sreemoolanadhan, M. T. Sebastian and P. Mohanan (Mater. Res. Bull 30, 1996, pp 653) have reported the dielectric properties of the solid solution BaₓSr₅₋ₓNb₄O₁₅ (x=0, 1, 2, 3, 4, 5) wherein the system show dielectric constants in the range 38-50 and Qxf in the range 6,600-44,000 GHz. The ceramics have hexagonal crystal structure. C. Veneis, P. K. Davies, T. Negas and S. Bell (Mater. Res. Bull. 31(5) 1996 pp 431-437) have reported that Ba₅Nb₄O₁₅ has dielectric constant of 39, Qxf=26,000 and τ_{f}=+78 ppm/° C. The high τ_{f} values of the ceramics render them unsuitable for practical applications.

### OBJECTS OF THE INVENTION

The main object of the present invention is to provide a novel microwave dielectric composition 5AO-2B₂O₅ (A=Ba, Sr, Ca, Mg, Zn; B=Nb, Ta) and achieving temperature compensation by stacking the resonators with positive and negative temperature coefficients of resonant frequency which obviates the drawbacks detailed above.

Another object of the present invention is to provide novel microwave dielectric ceramic composition by tailoring the dielectric properties of the high performance ceramics in the 5AO-2B₂O₅ (A=Ba, Sr, Ca, Mg, Zn; B=Nb, Ta) system either by forming solid solution phases or by forming mixtures like xZnO-(5-x)MgO-2Nb₂O₅(0<x<5).

Yet another object of the present invention is to provide to tune the microwave dielectric properties of the above ceramics and hence to achieve temperature compensation by stacking dielectric resonators with positive and negative τ_{f}s.

### BRIEF DESCRIPTION OF THE ACCOMPANYING DRAWINGS

FIG. 1 shows the variation of εᵣ and τ_{f} with x.

FIG. 2 shows the effective εᵣ versus volume fraction of 5ZnO-2Nb₂O₅.

FIG. 3 shows the effective τ_{f} versus volume fraction of 5ZnO-2Nb₂O₅.

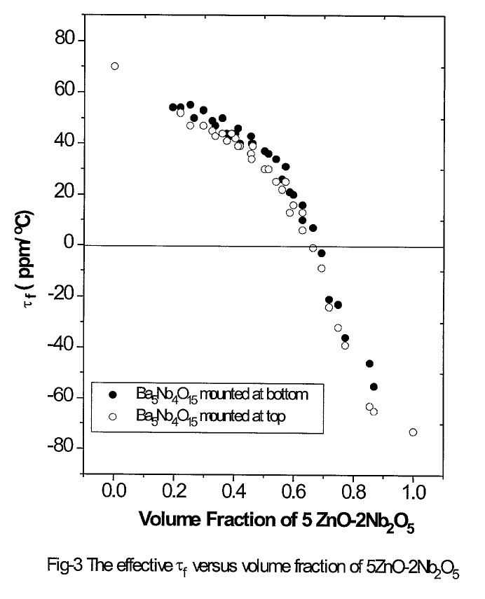

### SUMMARY OF THE INVENTION

Accordingly the present invention provides a novel microwave dielectric composition of the general formula 5AO-2B₂O₅ wherein A=Ba, Sr, Ca, Mg or Zn and B=Nb or Ta.

In one embodiment of the invention, the dielectric constant is in the range 11±1 to 42±1, quality factor—frequency product in the range 2000 and 88,000 and temperature coefficient of resonant frequency in the range +140±7 and −73±5 ppm/° C.

In another embodiment of the invention, the ceramic composition is of the formula Ba₅Ta₄O₁₅ and wherein the dielectric constant is 28±1, quality factor frequency product greater than 32000 and temperature variation of resonant frequency 8±4 ppm/° C.

In another embodiment of the invention, the ceramic composition is of the formula 5ZnO-2Nb₂O₅, and wherein the dielectric constant is 22±1, quality factor-frequency product greater than 88,000 and temperature variation of resonant frequency −73±5 ppm/° C.

In another embodiment of the invention, the ceramic composition is of the formula xA′-(5−x)A″-2[yB′-(1−y)B″]₂O₅(A′, A″=Ba, Sr, Ca, Mg, Zn; B′, B″=Nb, Ta) wherein 0<x<5 and 0<y<1.

In another embodiment of the invention, the ceramic composition is of the formula xZnO-(5−x)MgO-2Nb₂O₅ wherein 0<x<5.

In another embodiment of the invention, wherein 1.5<x<5 and wherein the dielectric constant is in the range 18±1 and 22±1, quality factor-frequency product is in the range 36000 to 89000 and temperature variation of resonant frequency is in the range −56±3 and −73±3 ppm/° C.

In another embodiment of the invention, the ceramic composition is of the formula xCaO-(5−x)ZnO-2Nb₂O₅ wherein 0<x<1 and wherein the dielectric constant is in the range 20±1 and 21±1, quality factor-frequency product is in the range 44,000 to 79,000 and temperature variation of resonant frequency is in the range −55±3 and −69±5 ppm/° C.

In another embodiment of the invention, the ceramic composition is of the formula 0.5CaO-4.5ZnO-2Nb₂O₅ wherein the dielectric constant is 21±1, quality factor-frequency product >79,000 and temperature variation of resonant frequency is in the range −55±3 ppm/° C.

In another embodiment of the invention, the ceramic composition is of the formula A₅B′ₓB″₄₋ₓO15 (A=Ba, Sr, Mg) [0<x<4] wherein the dielectric constant in the range 11±1 and 36±1, quality factor-frequency product between 3,000 and 25,000 and temperature variation of resonant frequency in the range −36±3 and +35±3 ppm/° C.

The invention also relates to stacked resonators consisting of the above ceramics with opposite τ_{f} values to tune the τ_{f} to near to zero values.

In another embodiment of the invention, the stacked resonators are between Ba₅Nb₄O₁₅ and 5ZnO-2Nb₂O₅ ceramics wherein the volume fraction of 5ZnO-2Nb₂O₅ is in the range 0.6 and 0.7 where the dielectric constant varies from 26 to 30 and τ_{f} varies between 20 and −20 ppm/° C.

In another embodiment of the invention, the microwave dielectric composition is of formula 5AO-2B₂O₅ wherein A=Ba, Sr, Ca or Mg, Zn; B=Nb or Ta, said process comprising reacting a carbonate or oxide of A with a pentoxide of B.

In another embodiment of the invention, the solid solutions or mixture phases with the general formula xA′-(5−x)A″-2Nb₂O₅ (A′, A″=Ca, Mg or Zn) is prepared by mixing calcium carbonate or magnesium oxide and zinc oxide with niobium pentoxide in the x:5−x:2 ratio.

In another embodiment of the invention, 0<x<1 when A′=Ca and A″=Zn.

In another embodiment of the invention, x=0.5, 1, 1.5, 2.0, 2.25, 2.5, 2.75, 3.0, 3.5, 4.0 and 4.5 when A′=Zn and A″=Mg, the mixture phases being prepared using the solid state ceramic route.

In another embodiment of the invention, the solid solution is prepared using BaCO₃, SrCO₃ or MgO with Nb₂O₅ and Ta₂O₅ in the appropriate molar ratio for 5AO-(x/2)Nb₂O₅-((4−x)/2)Ta₂O₅ (x=1, 2, 3) where A=Ba, Sr and Ca.

In one embodiment of the invention, the microwave dielectric ceramic comprises Mg₅Ta₄O₁₅; Mg₅Ta₄O₁₅; Sr₅Ta₄O₁₅; Ba₅Ta₄O₁₅; Mg₅Nb₄O₁₅; Mg₅Nb₄O₁₅; 5ZnO-2Nb₂O₅; 5CaO-2Ta₂O₅ and 5CaO-2Nb₂O₅.

In another embodiment of the invention temperature compensation is achieved by stacking the resonators with positive and negative temperature coefficients of resonant frequency by preparing the perovskites of the invention in the powder form, moulding of the powder in the suitable shape, drying, sintering and final treatment.

In another embodiment of the invention the solid solutions or mixture phases with the general formula xA′-(5−x)A″-2Nb₂O₅ (A′, A″=Ca, Mg or Zn) are prepared by mixing calcium carbonate or magnesium oxide and zinc oxide with niobium pentoxide in the x:(5−x):2 ratio.

In another embodiment of the invention, in A₅B₄O₁₅ ceramic the valency of A is two and that of B is five.

### DETAILED DESCRIPTION OF THE INVENTION

The solid solutions or mixture phases with the general formula xA′-(5−x)A″-2Nb₂O₅ (A′, A″=Ca, Mg or Zn) are prepared by mixing calcium carbonate or magnesium oxide and zinc oxide with niobium pentoxide in the x:(5−x):2 ratio. When A′Ca and A″=Zn, 0<x<1. When A′=Zn and A″=Mg and x=0.5, 1, 1.5, 2.0, 2.25, 2.5, 2.75, 3.0, 3.5, 4.0 and 4.5, the mixture phases are prepared for using the solid state ceramic route.

For 5AO-(x/2)Nb₂O₅-((4−x)/2)Ta₂O₅(x=1, 2, 3) where A=Ba, Sr and Ca the solid solutions are prepared using BaCO₃, SrCO₃ or MgO with Nb₂O₅ and Ta₂O₅ in the appropriate molar ratio.

The stacking of resonators having opposite τ_{f} values is studied to achieve temperature compensation.

In A₅B₄O₁₅ ceramic the valency of A is two and that of B is five. The calcium, Magnesium and zinc are attempted to substitute at A site keeping niobium at B site to get the respective niobates. In another series keeping the tantalum at B, barium, strontium, calcium and magnesium are attempted to substitute at A site in order to obtain the respective tantalates. In the case of ceramics having the similar structure, the atoms of a particular site may be replaced by another atom of the same valency and nearly the same ionic radius to form solid solution phases with intermediate dielectric constant and temperature coefficient of resonant frequencies.

The A₅B₄O₁₅ system provides ceramic materials with large range of dielectric constant, Q factor and positive and negative temperature coefficient of resonant frequencies and hence provides good scope for tuning the dielectric properties of ceramics with similar structure.

The present system of ceramics is useful for applications as dielectric resonators in communication systems and as substrates in microwave integrated circuits. Compared to the use of alumina substrates they decrease the size not only for strip line resonators and filters but also for all microwave circuits. It is also possible to use these dielectric materials in the fabrication of devices such as circulators, phase shifters etc. for impedance matching. The dielectric resonators based on the above compounds are also useful for the fabrication of dielectric resonator antennas. Solid solution formation in the above system enables to tune the dielectric constant and temperature variation of resonant frequency in the Ba₅Nb₄O₁₅ type hexagonal perovskites.

The detailed description of this invention will now be presented with specific examples. It is to be understood that the invention is not limited to the details of the illustrated examples.

### EXAMPLE-1

The A₅B₄O₁₅ type compounds are prepared by allowing the respective carbonates or oxides of A (A=Ca, Mg, Zn) to react with the pentoxides of B (Nb or Ta) through the solid-state ceramic route. The oxides or carbonates of A are wet mixed with niobium pentoxide/tantalum pentoxide in the molar ratio. The mixed powder is calcined in the range 1100° C.-1400° C. and cooled to the room temperature. The calcine is ground well, PVA is added as the binder, dried and again ground. The resultant fine powder is pellettized in the appropriate size for the measurement (5-9 mm in height and 11 mm in diameter). The careful design of the dimensions of the samples is a prerequisite for the accuracy of the microwave dielectric measurements. The height of the sintered samples should be less than their diameter for the accuracy of the results. The D/L (D=Diameter; L=length) ratio of 2-2.3 is preferable for the Q factor measurements. The sintering temperatures of the samples were optimized at different temperatures in the range 1220-1625° C. The sintered samples are polished well to avoid any irregularities on the flat surface and are used for measurements. The microwave dielectric constant is measured using Hakki-Coleman dielectric post resonator method. The resonator is placed between two gold-coated copper metallic plates and microwave energy is coupled through an E-field probe to excite various resonant modes. Among the various resonant modes the TE₀₁₁ mode is selected for the measurement.

The above ceramics resonate at frequencies between 4 and 10 GHz. The quality factors of the samples are measured at the TE_{01δ} mode resonant frequency using a cavity method [Jerzy Krupka, Krzytof Derzakowsky, Bill Riddle and James Baker Jarviz, Meas. Sci. Technol. 9(1998), 1751-1756]. The inner wall of the copper metallic cavity is silver coated. The sample is mounted on a cylindrical quartz crystal. The measurement is done in the transmission mode. The temperature variation of resonant frequency (τ_{f}) can be measured by noting the variation of TE_{01δ} mode resonant frequency with temperature. The τ_{f} is calculated using the formula

τ_{f}(1/f)×(Δf/ΔT)

where Δf is the variation of resonant frequency from the room temperature (usually 20° C.) resonant frequency and ΔT is the difference in temperature from room temperature. The microwave dielectric data for the system of materials is presented in Table-1.

TABLE 1
The microwave dielectric properties of A₅B₄O₁₅ ceramics

| Material | ε^{′} | Q × f (GHz) | τ_{f} (ppm/° C.) |
|---|---|---|---|
| Mg₅Ta₄O₁₅ | 17 ± 1 | 15000 | −15 ± 3 |
| Mg₅Ta₄O₁₅* | 11 ± 1 | 18000 | −14 ± 3 |
| Sr₅Ta₄O₁₅ | 41 ± 1 | 2400 | —** |
| Ba₅Ta₄O₁₅ | 28 ± 1 | 32000 | 8 ± 4 |
| Mg₅Nb₄O₁₅ | 14 ± 1 | 15000 | −58 ± 3 |
| Mg₅Nb₄O₁₅* | 11 ± 1 | 37000 | −54 ± 3 |
| 5ZnO-2Nb₂O₅ | 22 ± 1 | 88000 | −73 ± 5 |
| 5CaO-2Ta₂O₅ | 41 ± 1 | 6000 | 140 ± 7 |
| 5CaO-2Nb₂O₅ | 32 ± 1 | 7000 | −37 ± 3 |

*Heated MgO is used for calcinations
**Measurement is not possible due to poor resonance

### EXAMPLE-2

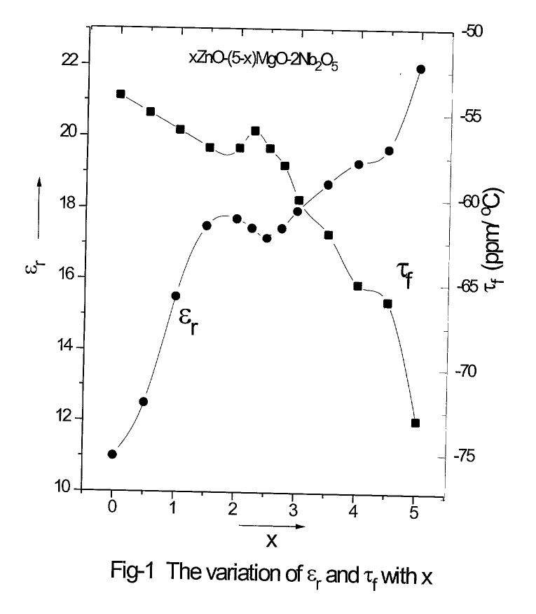

The ceramics with the general formula xZnO-(5−x)MgO-2Nb₂O₅ are prepared by mixing magnesium oxide, zinc oxide and niobium pentoxide in the x:(5−x):2 with x=0.5, 1, 1.5, 2.0, 2.25, 2.5, 2.75, 3.0, 3.5, 4.0 and 4.5. The magnesium oxide powder is heated at 1000° C. for 3 hours to convert the small percentage of carbonate into oxide. The preparation and characterization of the compounds follow the same procedure described in Example 1. The calcination and sintering are done at temperatures in the range 1100-1250° C. and 1250° C.-1400° C. respectively. The results are shown in Table-2. A plot of the variation of εᵣ and τ_{f} with x is also shown in FIG. 1.

TABLE 2
The microwave dielectric properties of xZnO-(5-x)MgO-2Nb₂O₅

| X | εᵣ | τ_{f} ppm/° C. | Q × f (GHz) |
|---|---|---|---|
| 0 | 11 ± 1 | −54 ± 3 | 37350 |
| 0.5 | 14 ± 1 | −55 ± 3 | 18494 |
| 1.0 | 16 ± 1 | −56 ± 3 | 20325 |
| 1.5 | 17 ± 1 | −56 ± 3 | 36397 |
| 2.0 | 18 ± 1 | −57 ± 3 | 88862 |
| 2.25 | 18 ± 1 | −57 ± 3 | 53985 |
| 2.5 | 18 ± 1 | −57 ± 3 | 59519 |
| 2.75 | 17 ± 1 | −57 ± 3 | 31937 |
| 3.0 | 18 ± 1 | −58 ± 3 | 33722 |
| 3.5 | 19 ± 1 | −60 ± 3 | 47965 |
| 4.0 | 19 ± 1 | −65 ± 3 | 60260 |
| 4.5 | 20 ± 1 | −66 ± 3 | 45941 |
| 5.0 | 22 ± 1 | −73 ± 3 | 87948 |

### EXAMPLE-3

The ceramics with the general formula xCaO-(5−x)ZnO-2Nb2O₅ are prepared by mixing calcium carbonate, zinc oxide and niobium pentoxide in the x:5−x:2 with x=0.1, 0.2, 0.5, 1.0. The preparation and characterization of the compounds follow the same procedure described in EXAMPLE-1. The calcinations and sintering are done at temperatures in the range 1050-1075° C. and 1190-1200° C. respectively. Results are shown in Table-3. The ceramics are glossy and do not resonate for x=1.0.

TABLE 3
Microwave dielectric properties of xCaO-(5-x)ZnO-2Nb₂O₅

| X | εᵣ | τ_{f} ppm/° C. | Q × f (GHz) |
|---|---|---|---|
| 0.1 | 20 ± 1 | −69 ± 5 | 43705 |
| 0.2 | 21 ± 1 | −68 ± 5 | 55872 |
| 0.5 | 21 ± 1 | −55 ± 3 | 78732 |

### EXAMPLE-4

A₅Nb₄₋ₓTaₓO₁₅ solid solutions (A=Ba, Sr and Mg) are prepared by mixing the respective oxides or carbonates of A with niobium pentoxode or tantalum pentoxide in the appropriate ratios for x=1, 2, 3. The magnesium oxide powder is usually heated at 1000° C. for 3 hours to convert the small percentage of carbonate into oxide weighed before cooling. The preparation and characterization of the compounds follow the same procedure described in Example 1. The calcination are done in the temperature a range 1250-1400° C. for 4 to 8 hours and sintering in the range 1435-1600° C. for 2 to 4 hours. The results are shown in Table-4.

TABLE 4
Microwave dielectric properties of A₅Nb₄₋ₓTaₓO₁₅ ceramics
(A = Ba, Sr and Mg)

| Material | εᵣ | τ_{f} ppm/° C. | Q × f (GHz) |
|---|---|---|---|
| Ba₅Nb₃TaO₁₅ | 32 ± 1 | +35 ± 3 | 4900 |
| Ba₅Nb₂Ta₂O₁₅ | 27 ± 1 | +22 ± 3 | 11000 |
| Ba₅NbTa₃O₁₅ | 26 ± 1 | +14 ± 3 | 22000 |
| Sr₅Nb₃TaO₁₅ | 36 ± 1 | +31 ± 3 | 7000 |
| Sr₅Nb₂Ta₂O₁₅ | 33 ± 1 | −2 ± 3 | 3000 |
| Sr₅NbTa₃O₁₅ | 32 ± 1 | −32 ± 3 | — |
| Mg₅Nb₃TaO₁₅ | 11 ± 1 | −55 ± 3 | 8400 |
| Mg₅Nb₂Ta₂O₁₅ | 11 ± 1 | −54 ± 3 | 25000 |
| Mg₅NbTa₃O₁₅ | 11 ± 1 | −54 ± 3 | 17000 |

### EXAMPLE 5

Ba₅Nb₄O₁₅-5ZnO-2Nb₂O₅ Stacked Resonators

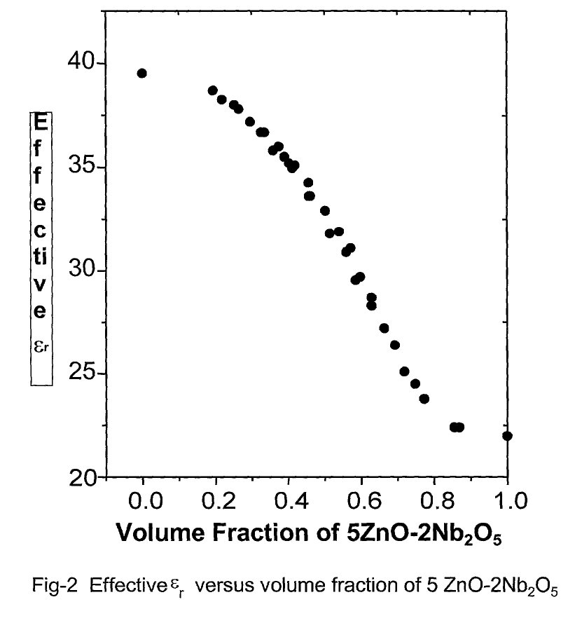

The hexagonal type Ba₅Nb₄O₁₅ is reported to have εᵣ=39.0, high Qxf up to 25,000 and τ_{f}=+78 ppm/° C. where as 5ZnO-2Nb₂O₅ has εᵣ=22, high Qxf up to 88,000 and τ_{f}=−73 ppm/° C. The formation of solid solution between the above two ceramics for the tuning of microwave dielectric properties is not possible due to large difference in the ionic radii of Ba and Zn and also due to the difference in crystal structure. Hence a stacked resonator between the above ceramics is tried. The Ba₅Nb₄O₁₅ is formed from a stoichiometric mixture of high purity BaCO₃ and Nb₂O₅ by calcining at 1200-1225° C. for 5 hour and sintered at 1200° C. for 2 hour where as 5ZnO-2Nb₂O₅ is formed from a stoichiometric mixture of high purity ZnO and Nb₂O₅ at 1050° C. for 4 hour and sintered at 1380° C. for 2 hour through the solid state route. The preparation conditions are well controlled such that diameters of the final sintered pellets are nearly the same (The mean deviation is <0.5%). The sintered pellets were polished well. The microwave dielectric constants and Q factors of the pellets were characterized accurately using the cavity method. The dimensions and the microwave parameters measured for the samples were shown in Table-5. The average dielectric constant measured for Ba₅Nb₄O₁₅ pellets is 39.5 and that of 5ZnO-2Nb₂O₅ pellets is 22 with less than 0.3% deviation. The average value of Qxf for Ba₅Nb₄O₁₅ samples is 21845 with a maximum deviation of 16% and those for 5ZnO-2Nb₂O₅ are 77,560 and 4% respectively. The pellets of one type say 5ZnO-2Nb₂O₅ are placed over the other in between two gold-coated copper metallic plate (the Hakki-Coleman setup) and microwave is applied. The pellets can be glued together using low-loss ceramic glues like cyanoacrylic. The resonant structure act like a single dielectric resonator mounted in the set up. The equivalent dielectric resonator can be assumed to have a dielectric constant ε_{eff} with length and diameter is respectively obtained from the sum of lengths and average of the diameters of the individual pellets. The TE₀₁₁ mode resonant frequency of the resonant system is noted. The pellets are reversed and the resonant frequency is noted. The effective dielectric constant (ε_{eff}) is calculated using the formulae suggested by Hakki and Coleman. The experiment is repeated for different possible combinations of the pellets. The results are tabulated in Table-6. The variation of the dielectric constant with volume fraction is also given in FIG. 2.

The quality factors were measured using a cavity method described in Example-1. The Q factor and resonant frequency vary with the reversal of the pellets. The experiment is repeated with different possible combination of pellets. The results were tabulated in Table-7.

TABLE 5
The microwave characteristics Ba₅Nb₄O₁₅ and 5ZnO-2Nb₂O₅ samples

| Material | Pellet Code | L (mm) | D (mm) | F (GHz) | Q | εᵣ | τ_{f} (ppm/° C.) |
|---|---|---|---|---|---|---|---|
| Ba₅Nb₄O₁₅ | B1 | 7.960 | 9.63 | 4.678 | 4370 | 39.4 | 73 |
| | B2 | 6.820 | 9.64 | 4.7664 | 4310 | 39.6 | 74 |
| | B3 | 5.690 | 9.63 | 4.9275 | 3915 | 39.5 | 74 |
| | B4 | 4.490 | 9.65 | 5.1804 | 4832 | 39.6 | — |
| | B5 | 3.370 | 9.66 | 5.5936 | 4225 | 39.4 | — |
| | B6 | 2.230 | 9.66 | —* | — | — | — |
| | B7 | 1.140 | 9.72 | —* | — | — | — |
| 5ZnO- | Z1 | 7.590 | 9.670 | 6.184 | 12145 | 22.1 | −73 |
| 2Nb₂O₅ | Z2 | 6.670 | 9.670 | 6.296 | 12570 | 22.0 | −72 |
| | Z3 | 5.710 | 9.700 | 6.475 | 12010 | 22.0 | −73 |
| | Z4 | 4.770 | 9.675 | 6.738 | 11653 | 21.9 | — |
| | Z5 | 3.830 | 9.690 | 7.096 | 10893 | 21.9 | — |
| | Z6 | 2.860 | 9.720 | —* | — | — | — |
| | Z7 | 1.910 | 9.680 | —* | — | — | — |

*Could not be measured due to the undersize of sample

TABLE 6
The εᵣ and τ_{f} of the stacked resonators between Ba₅Nb₄O₁₅ and 5ZnO-2Nb₂O₅

| Pellets | | Effective | Effective | V_{f} of | B down & Z up | | | B up & Z down | | |
|---|---|---|---|---|---|---|---|---|---|---|
| used for | | Length | Diameter | 5ZnO- | f | | τ_{f} | f | | τ_{f} |
| stacking | | (L) mm | (D) mm | 2Nb₂O₅ | (GHz) | εᵣ | ppm/° C. | (GHz) | εᵣ | ppm/° C. |
| B1 | Z7 | 9.870 | 9.655 | 0.1939 | 5.0237 | 38.7 | 54 | — | — | — |
| | Z6 | 10.820 | 9.675 | 0.2652 | 4.9295 | 37.8 | 50 | — | — | — |
| | Z5 | 11.790 | 9.66 | 0.3255 | 4.8792 | 36.7 | 49 | 4.8630 | 36.0 | 45 |
| | Z4 | 12.730 | 9.65 | 0.3752 | 4.8211 | 36.0 | 44 | 4.8364 | 35.8 | 41 |
| | Z3 | 13.670 | 9.665 | 0.4186 | 4.8042 | 35.1 | 40 | 4.8021 | 35.2 | 39 |
| B2 | Z7 | 8.730 | 9.660 | 0.2192 | 5.2671 | 38.3 | 54 | 5.2676 | 38.3 | 52 |
| | Z6 | 9.680 | 9.680 | 0.2964 | 5.1527 | 37.2 | 53 | 5.1534 | 37.2 | 47 |
| | Z5 | 10.650 | 9.665 | 0.3603 | 5.0700 | 35.8 | 50 | 5.0563 | 36.2 | 44 |
| | Z4 | 11.590 | 9.660 | 0.4121 | 5.0169 | 35.0 | 46 | 5.0151 | 35.0 | 39 |
| | Z3 | 12.530 | 9.670 | 0.4556 | 4.9634 | 34.3 | 43 | 4.9658 | 34.2 | 36 |
| B3 | Z7 | 7.600 | 9.665 | 0.2518 | 5.5950 | 38.0 | 55 | 5.5803 | 38.2 | 47 |
| | Z6 | 8.550 | 9.675 | 0.3358 | 5.4308 | 36.7 | 47 | 5.4390 | 36.6 | 43 |
| | Z5 | 9.520 | 9.660 | 0.4031 | 5.3266 | 35.2 | 44 | 5.3368 | 35.0 | 42 |
| | Z4 | 10.460 | 9.650 | 0.4566 | 5.2587 | 33.6 | 40 | 5.2664 | 33.5 | 34 |
| | Z3 | 11.400 | 9.665 | 0.5018 | 5.2011 | 32.9 | 37 | 5.1996 | 32.9 | 30 |
| | Z2 | 12.360 | 9.650 | 0.5401 | 5.1630 | 31.9 | 34 | 5.1720 | 31.8 | 25 |
| | Z1 | 13.280 | 9.650 | 0.5720 | 5.1378 | 31.1 | 31 | 5.1327 | 31.1 | 25 |
| B4 | Z6 | 7.350 | 9.685 | 0.3900 | 5.8711 | 35.5 | 43 | 5.8746 | 35.4 | 44 |
| | Z5 | 8.320 | 9.670 | 0.4608 | 5.7344 | 33.6 | 40 | 5.7221 | 33.6 | 39 |
| | Z4 | 9.260 | 9.660 | 0.5154 | 5.6380 | 31.8 | 36 | 5.6326 | 31.9 | 30 |
| | Z3 | 10.200 | 9.675 | 0.5604 | 5.5507 | 30.9 | 26 | 5.5493 | 31.0 | 22 |
| | Z2 | 11.160 | 9.660 | 0.5979 | 5.4956 | 29.7 | 20 | 5.4930 | 29.8 | 16 |
| | Z1 | 12.080 | 9.660 | 0.6286 | 5.4607 | 28.7 | 16 | 5.4590 | 28.7 | 13 |
| B5 | Z4 | 8.140 | 9.670 | 0.5862 | 6.1736 | 29.6 | 21 | 6.1642 | 29.6 | 13 |
| | Z3 | 9.080 | 9.680 | 0.6293 | 6.0500 | 28.3 | 10 | 6.0453 | 28.3 | 6 |
| | Z2 | 10.040 | 9.665 | 0.6644 | 5.9471 | 27.2 | 7 | 5.9505 | 27.2 | −1 |
| | Z1 | 10.960 | 9.665 | 0.6926 | 5.8724 | 26.4 | −3 | 5.8789 | 26.3 | −9 |
| B6 | Z3 | 7.940 | 9.680 | 0.7195 | 6.7447 | 25.1 | −21 | 6.7494 | 25.1 | −24 |
| | Z2 | 8.900 | 9.665 | 0.7495 | 6.5507 | 24.5 | −23 | 6.5492 | 24.5 | −32 |
| | Z1 | 9.820 | 9.665 | 0.7730 | 6.3943 | 23.8 | −36 | 6.3886 | 23.8 | −39 |
| B7 | Z2 | 7.810 | 9.695 | 0.8545 | 7.1497 | 22.4 | −46 | 7.1552 | 22.4 | −63 |
| | Z1 | 8.730 | 9.695 | 0.8695 | 6.8612 | 22.4 | −55 | 6.8627 | 22.4 | −65 |

TABLE 7
The resonant frequency and Q factor of the stacked resonators
(Measured using cavity resonator setup)

| Pellets | | B down & Z up | | | B up and Z down | | |
|---|---|---|---|---|---|---|---|
| used for | | f | | Q × f | f | | Q × f |
| stacking | | (GHz) | Q | GHz | (GHz) | Q | GHz |
| B2 | Z7 | 4.702 | 4569 | 21483 | 4.764 | 4073 | 19403 |
| | Z6 | 4.694 | 4237 | 19888 | 4.836 | 4102 | 19837 |
| B3 | Z7 | 4.828 | 3845 | 18563 | 4.860 | 4018 | 19527 |
| | Z6 | 4.808 | 3750 | 18030 | 4.885 | 3560 | 17391 |
| | Z5 | 4.795 | 3767 | 18062 | 4.980 | Modes interfere | |
| B4 | Z7 | 5.010 | 4880 | 24449 | 5.041 | 4962 | 25013 |
| | Z6 | 4.973 | 5080 | 25263 | 5.035 | 4922 | 24782 |
| | Z5 | 4.956 | 4980 | 24681 | 5.073 | 4921 | 24964 |
| | Z4 | 4.946 | 4980 | 24631 | 5.171 | 4800 | 24821 |
| | Z3 | 4.944 | 4868 | 24067 | 5.369 | 4800 | 25771 |
| B5 | Z7 | 5.315 | 4951 | 26315 | 5.334 | 4911 | 26195 |
| | Z6 | 5.249 | 5166 | 27116 | 5.286 | 4950 | 26166 |
| | Z5 | 5.212 | 5150 | 26842 | 5.281 | 5070 | 26775 |
| | Z4 | 5.187 | 5242 | 27190 | 5.318 | 5145 | 27361 |
| | Z3 | 5.174 | 5230 | 27060 | 5.420 | 4850 | 26287 |
| | Z2 | 5.171 | 5246 | 27127 | 5.635 | 5175 | 29161 |
| B6 | Z7 | 5.793 | 5332 | 30888 | 5.813 | 5252 | 30530 |
| | Z6 | 5.672 | 5660 | 32104 | 5.741 | 5663 | 32511 |
| | Z5 | 5.594 | 5900 | 33005 | 5.649 | 5900 | 33329 |
| | Z4 | 5.539 | 6060 | 33566 | 5.617 | 5950 | 33421 |
| | Z3 | 5.502 | 6085 | 33480 | 5.633 | 6102 | 34373 |
| | Z2 | 5.482 | 6180 | 33879 | 5.720 | 6427 | 36762 |
| B7 | Z6 | 6.396 | 3050 | 19508 | 6.429 | 3150 | 20251 |
| | Z5 | 6.262 | 3360 | 21040 | 6.244 | 3600 | 22478 |
| | Z4 | 6.068 | 3760 | 22815 | 6.107 | 3920 | 23939 |
| | Z3 | 5.963 | 4030 | 24031 | 6.022 | 4675 | 28153 |
| | Z2 | 5.889 | 4350 | 25617 | 5.985 | 5468 | 32726 |
| | Z1 | 5.875 | 4985 | 29287 | 5.997 | 6780 | 40660 |

The inventive system of microwave ceramics has high dielectric constant, high quality factor and small temperature variation of resonant frequencies. Ba₅Ta₄O₁₅ with dielectric constant of 28-29, quality factor greater than 5500 and low τ_{f} between 4 and 13 ppm/° C. is a potential material for practical applications. The 5ZnO-2Nb₂O₅ samples show very high Q factor which is greater than 12000, high dielectric constant of 22 and intermediate τ_{f} of −65 to −75 ppm/° C. The 5AO-2B₂O₅ ceramic compositions give the A₅B₄O₁₅ type ceramics only when Ba, Sr and Mg are used at the A site. The mixture phases formed from 5ZnO-2Nb₂O₅ and 5CaO-2Nb₂O₅ have negative τ_{f} whereas 5CaO-2Ta₂O₅ has positive τ_{f}. The phases were identified to be AB₂O₆, A₂B₂O₇ or A₃B₂O₈ type ceramics. The ceramic system are useful for tuning the dielectric properties of the hexagonal perovskites to the extent, which is permissible by substitution, doping, solid solution or by forming mixtures without much degradation of the required properties.

In order to tune the microwave dielectric properties of the Mg₅Nb₄O₁₅ ceramics, the magnesium site is attempted to replace with zinc, which resulted in the multiphase ceramics with the compositional formula xZnO-(5−x)MgO-Nb₂O₅. The above said ceramics show εᵣ in the range 11 to 22, Qxf between 18000 and 89000 and τ_{f} between −54±3 and −73±3 ppm/° C. The system gives ceramics with very high Qxf in the range 36,000 to 89,000 with εᵣ in the range 18+1 to 22±1 for 1.5<x<5. In another attempt, the zinc site in the 5ZnO-2Nb₂O₅ mixture system is tried to replace with calcium and the resulted mixture phased ceramics may be represented by the compositional formula xCaO-(5−x)ZnO-2Nb₂O₅. The results are summarized in Table-3. The substitution of Ca up to x=0.5 decreases the τ_{f} from −73±3 to −55±3 ppm/° C. For x=1 the samples do not resonate. The replacement of B site niobium with tantalum in the hexagonal A₅Nb₄O₁₅ (A=Ba, Sr, Mg) ceramics gives A₅Nb₄₋ₓTaₓO₁₅ (A=Ba, Sr, Mg) solid solution phases. The microwave dielectric properties were given in Table-4. The ceramics has Ba₅Nb₄₋ₓTaₓO₁₅ (x=1, 2, 3) solid solutions show high εᵣ from 26 to 32, low τ_{f} from +14 to +35 ppm/° C. and high Qxf from 4849 to 21683 GHz. Sr₅Nb₄₋ₓTaₓNb₄O₁₅ (x=1, 2, 3) show high εᵣ between 32 and 36 for 1<x<3. The Mg₅Nb₄₋ₓTaₓO₁₅ ceramics have τᵣ of 11 with high quality factor. Hence the set of materials in the 5AO-2B₂O₅ provide microwave dielectrics with a wide range of εᵣ (11-42), Q factor up to 88,000 and positive and negative τ_{f} (between −73 and 140 ppm/° C.) useful for applications.

The microwave dielectric properties can be suitably tuned by stacking cylindrical resonators with negative τ_{f} over those with positive τ_{f} and vice versa. The microwave dielectric response of the Ba₅Nb₄O₁₅-5ZnO-2Nb₂O₅ stacked resonator system is given in Table-6 and Table-7. The Q factor of the system increases with the volume fraction of 5ZnO-2Nb₂O₅ whereas effective dielectric constant shows a reverse trend and it decreases from 39 to 22. The τ_{f} gradually decreases from high positive value to high negative value with 5ZnO-2Nb₂O₅. When the volume fraction of 5ZnO-2Nb₂O₅ 0.6 to 0.7 the effective dielectric constant is between 26 and 30, Qxf between 26000 and 34000 and τ_{f} between 20 and −20 ppm/° C. Stacking provides a method suitable for tuning the dielectric properties of ceramics having high dielectric constant and Q factor even if their τ_{f} values are very high.

The main advantages of the present invention are

1. The inventive system of materials provides a large range of dielectric constant, quality factor with small temperature variation of resonant frequencies.

2. It provides dielectric resonator materials, which are useful for tuning the hexagonal perovskite with high dielectric constant and Q factor.

3. Some of the ceramics in the system have high dielectric constant and Q factor and low τ_{f} suitable for practical applications.

4. Achieving temperature compensation by stacking the resonators with positive and negative temperature coefficient of resonant frequencies coefficient of resonant frequency to near to zero by stacking dielectric resonators with positive and negative τ_{f}.

We claim

1. A microwave dielectric composition of a general formula 5AO-2B₂O₅ wherein A=Ba, Sr, Ca, Mg or Zn and B=Nb or Ta.

2. A microwave dielectric composition as claimed in claim 1 wherein the dielectric constant is in the range 11±1 to 42±1, quality factor—frequency product in the range 2000 and 88,000 and temperature coefficient of resonant frequency in the range +140±7 and −73±5 ppm/° C.

3. A microwave dielectric composition as claimed in claim 1 wherein the ceramic composition is of the formula Ba₅Ta₄O₁₅ and wherein the dielectric constant is 28±1, quality factor frequency product greater than 32000 and temperature variation of resonant frequency 8±4 ppm/° C.

4. A microwave dielectric composition as claimed in claim 1 wherein the ceramic composition is of the formula 5ZnO-2Nb₂O₅, and wherein the dielectric constant is 22±1, quality factor-frequency product greater than 88,000 and temperature variation of resonant frequency −73±5 ppm/° C.

5. A microwave dielectric composition as claimed in claim 1 wherein the ceramic composition is of the formula xA′-(5−x)A″-2[yB′-(1−y) B″]₂O₅(A′, A″=Ba, Sr, Ca, Mg, Zn; B′, B″=Nb, Ta) wherein 0<x<5 and 0<y<1.

6. A microwave dielectric composition as claimed in claim 1 wherein the ceramic composition is of the formula xZnO-(5−x)MgO-2Nb₂O₅ wherein 0<x<5.

7. A microwave dielectric composition as claimed in claim 6 wherein 1.5<x<5 and wherein the dielectric constant is in the range 18±1 and 22±1, quality factor-frequency product is in the range 36000 to 89000 and temperature variation of resonant frequency is in the range −56±3 and −73±3 ppm/° C.

8. A microwave dielectric composition as claimed in claim 1 wherein the ceramic composition is of the formula xCaO-(5−x)ZnO-2Nb₂O₅ wherein 0<x<1 and wherein the dielectric constant is in the range 20±1 and 21±1, quality factor-frequency product is in the range 44,000 to 79,000 and temperature variation of resonant frequency is in the range −55±3 and −69±5 ppm/° C.

9. A microwave dielectric composition as claimed in claim 8 wherein the ceramic composition is of the formula 0.5CaO-4.5ZnO-2Nb₂O₅ wherein the dielectric constant is 21±1, quality factor-frequency product >79,000 and temperature variation of resonant frequency is in the range −55±3 ppm/° C.

10. A microwave dielectric composition as claimed in claim 1 wherein the ceramic composition is of the formula A₅B′ₓB″₄₋ₓO15 (A=Ba, Sr, Mg) [0<x<4] wherein the dielectric constant in the range 11±1 and 36±1, quality factor-frequency product between 3,000 and 25,000 and temperature variation of resonant frequency in the range −36±3 and +35±3 ppm/° C.

11. The microwave dielectric composition of any of the preceding claims with opposite τ_{f} values to tune the τ_{f} to near to zero values.

12. The microwave dielectric composition in claim 11 further comprising Ba₅Nb₄O₁₅ and 5ZnO-2Nb₂O₅ ceramics wherein volume fraction of 5ZnO-2Nb₂O₅ is in range 0.6 and 0.7 where the dielectric constant varies from 26 to 30 and τ_{f} varies between 20 and −20 ppm/° C.

13. A process for the preparation of microwave dielectric composition of formula 5AO-2B₂O₅ wherein A=Ba, Sr, Ca or Mg, Zn; B=Nb or Ta, said process comprising reacting a coarbonate or oxide of A with a pentoxide of B.

14. A process as claimed in claim 13 wherein the solid solutions or mixture phases with the general formula xA′-(5−x)A″-2Nb₂O₅ (A′, A″=Ca, Mg or Zn) is prepared by mixing calcium carbonate or magnesium oxide and zinc oxide with niobium pentoxide in the x:(5−x):2 ratio.

15. A process as claimed in claim 13 wherein, 0<x<1 when A′=Ca and A″=Zn.

16. A process as claimed in claim 13 wherein, x=0.5, 1, 1.5, 2.0, 2.25, 2.5, 2.75, 3.0, 3.5, 4.0 and 4.5 when A′=Zn and A″=Mg, the mixture phases being prepared using the solid state ceramic route.

17. A process as claimed in claim 13 wherein the solid solution is prepared using BaCO₃, SrCO₃ or MgO with Nb₂O₅ and Ta₂O₅ in the appropriate molar ratio for 5AO-(X/2)Nb₂O₅-((4−x)/2)Ta₂O₅ (x=1, 2, 3) where A=Ba, Sr and Ca.
